(19) United States
(12) Patent Application Publication
(10) Pub. No.: US 2004/0148168 A1
(43) Pub. Date: Jul. 29, 2004

(54) Method and device for automatically differentiating and/or detecting acoustic signals

(76) Inventor: Tim Fingscheidt, Munchen (DE)

Correspondence Address: BELL, BOYD & LLOYD, LLC, P. O. BOX 1135, CHICAGO, IL, 60690-1135, US

(21) Appl. No.: 10/476,747

(22) PCT Filed: Apr. 8, 2002
(86) PCT No.: PCT/DE02/01277

(30) Foreign Application Priority Data
May 3, 2001 (DE) 101 21 532.0

(51) Int. Cl. G10L 15/12

(52) U.S. Cl. 704/240

(57) ABSTRACT

A method and device are provided for automatically differentiating and/or detecting acoustic signals, whereby the signals are statistically analyzed, at least in part, and their reflection coefficients of at least one are calculated. Thereafter, a comparison value, which is dependent exclusively on a single reflection coefficient, is calculated and compared with at least one predetermined reference value.

### BACKGROUND OF THE INVENTION

The present invention relates to a method and device for automatically differentiating and/or detecting acoustic signals, whereby the signals are statistically analyzed, at least in part, and their reflection coefficients of at least one order are calculated.

Statistical analysis of microphone signals for speech detection is generally known. In this statistical analysis, reflection coefficients, among other things, are calculated to ascertain whether or not a speech signal is present.

U.S. Pat. No. 5,749,067 discloses how a prediction error can be computed from a large number of reflection coefficients and the presence of a speech signal or a specific tone deemed to be detected if the error is less than a predetermined threshold value. Alternatively, a prediction gain also can be determined, in which case the speech signal or tone is considered to be detected if a threshold is exceeded.

The basic disadvantage of this method is that, in order to compute the prediction error, a complete pass taking in all the reflection coefficients rᵢ used for detection is necessary, as the prediction error is calculated from the product of all the (1-rᵢ²), where i=1 to n and n is the number of reflection coefficients used. The response time of a system of this kind is, of course, relatively slow, as in each case a complete loop via the number of reflection coefficients present must be completed before a decision takes place.

An example of a corresponding program in accordance with the aforementioned US patent application is given below.

signalactive = 0; /* default: signal not active */ predictionerror = 1.0;
for (k = 0; K < NUMCOEFFl, k++)
{
temp = 1.0 - reflectioncoeff[k] * reflectioncoeff [k]; predictionerror =
predictionerror * temp;
}
if (predictionerror < THRESHOLD)
signalactive = 1;

An object of the present invention is to devise a less complex and, therefore, more responsive method and device for automatically differentiating and/or detecting acoustic signals.

### SUMMARY OF THE INVENTION

The inventor has recognized that it is not absolutely necessary to compute the prediction error over all the reflection coefficients, but that it suffices to make the decision for differentiating and/or detecting acoustic signals on the basis of a single selected reflection coefficient. It should be noted here that the term “acoustic signals” refers to, for example, speech signals, DTMF signals (DTMT=discrete tone modulated frequency) or even the well-known fax identification signals. In addition, differentiating and/or detecting refers to distinguishing between silence and the presence of a signal. Acoustic signals also refer to all electronically transmitted signals which can be converted into acoustic signals, these mainly being microphone signals which produce electric voltage or current signals.

Accordingly, the present invention seeks to improve the method for automatically differentiating and/or detecting acoustic signals, whereby the signals are statistically analyzed, at least in part, and their reflection coefficients of at least one order are computed, such that a comparison value depending solely on a single reflection coefficient is calculated and compared with at least one predetermined reference value.

This significantly shortens the detection process, thereby allowing a more rapid response to changed situations.

Additional features and advantages of the present invention are described in, and will be apparent from, the following Detailed Description of the Invention.

### DETAILED DESCRIPTION OF THE INVENTION

According to the present invention, calculation of the comparison value allows for the sign of the reflection coefficient to be eliminated; e.g., by generating the absolute value of the reflection coefficient or calculating the square of the reflection coefficient. However, instead of eliminating the sign of the reflection coefficient in the computing process, an upper or lower limit also can be specified as a reference value so that a positive detection likewise results if the comparison value breaks out of these bounds.

In addition, a decision also can be made as to the presence or absence of voice activity if the comparison value is greater or less than at least one reference value. However, this method also can be used for determining whether the transmitted speech is voiced or unvoiced, or to differentiate tone or non-tone signals; e.g., the presence of DTMF signals.

According to the present method, it is also proposed to improve a device for automatically differentiating and/or detecting acoustic signals, particularly in digital voice transmission systems which can statistically analyze the acoustic signals, at least in part, and can compute their reflection coefficients of at least one order, in the respect that a calculation of a comparison value is performed, the comparison value depending solely on a single reflection coefficient and, in addition, that a comparison of the comparison value with at least one predetermined reference value is performed.

This also achieves a much faster system response compared to known systems, as the computation is much less complex.

According to the present invention, an elimination of the sign of the reflection coefficient also can be performed; e.g., by calculating the absolute value of the reflection coefficient or calculating the square of the reflection coefficient.

It is additionally proposed to discriminate between voice activity and voice inactivity depending on whether the comparison value of at least one reference value is exceeded or undershot.

Accordingly, a discrimination also can be performed between voiced and unvoiced speech or tone or non-tone signals, depending on whether the comparison value of at least one reference value is exceeded or undershot.

The above-described processor may be affected via either an appropriate circuit arrangement or program modules executed in a computer or processor.

Accordingly, the present invention also encompasses a computer program product with program coding capabilities for executing at least the steps according to at least one of the aforesaid method-related processor when the program coding is implemented on a computer or processor.

A computer program of this kind can, of course, be stored on a data carrier within the scope of the present invention.

A specific exemplary embodiment of the inventive idea is illustrated in the following program module expressed as pseudo-C code:

```
signalactive = 0; /* default: signal not active */
for (k = 0; k < NUMCOEFF2; k++)
{
if( abs (reflectioncoeff [k]) > THRESHOLD)
{
    signalactive = 1;
    break;
}
}
```

It is self-evident that before using this program module the reflection coefficients reflectioncoeff[k] must be pre-calculated in the known manner and the threshold value THRESHOLD must be pre-defined.

Comparison between the program according to the prior art and the program according to the present invention shows that, when the situation changes, the response time of this program is significantly faster, as a single event with overshooting reflection coefficient results in detection.

Although the present invention has been described with reference to specific embodiments, those of skill in the art will recognize that changes may be made thereto without departing from the spirit and scope of the present invention as set forth in the hereafter appended claims.

1. Method for automatically differentiating and/or detecting acoustic signals, whereby said signals are statistically analyzed at least in part and their reflection coefficients of at least one order are calculated, characterized in that a comparison value depending solely on a single reflection coefficient is calculated and compared with at least one predetermined reference value and that the sign of the reflection coefficient is eliminated when the comparison value is calculated.

2. Method according to claim 1, characterized in that the absolute value of the reflection coefficient is calculated as a comparison value.

3. Method according to one of the preceding claims 1 to 2, characterized in that the square of the reflection coefficient is calculated as a comparison value.

4. Method according to one of the preceding claims 1 to 3, characterized in that when the comparison value overshoots or undershoots one or more reference values, a decision as to voice activity or voice inactivity is made.

5. Method according to one of the preceding claims 1 to 4, characterized in that when the comparison value overshoots or undershoots one or more reference values, a decision as to voiced or unvoiced speech is made.

6. Method according to one of the preceding claims 1 to 5, characterized in that when the comparison value overshoots or undershoots one or more reference values, a decision as to tone signal or non-tone signal is made.

7. Device for automatically differentiating and/or detecting acoustic signals, particularly in digital voice transmission systems, means of statistically analyzing said acoustic signals at least in part and of computing their reflection coefficients of at least one order being provided, characterized in that a means of calculating a comparison value is provided, said comparison value depending solely on a single reflection coefficient and, in addition, that a means of comparing said comparison value with at least one predetermined reference value is provided, and that means of eliminating the sign of the reflection coefficient are provided.

8. Device according to claim 7, characterized in that means of calculating the absolute value of the reflection coefficient are provided.

9. Device according to one of the preceding claims 7 to 8, characterized in that means of calculating the square of the reflection coefficient are provided.

10. Device according to one of the preceding claims 7 to 8, characterized in that there are provided means of discriminating between voice activity and voice inactivity depending on whether the comparison value is greater or less than at least one reference value.

11. Device according to one of the preceding claims 7 to 10, characterized in that there are provided means of discriminating between voiced and unvoiced speech depending on whether the comparison value is greater or less than at least one reference value.

12. Device according to one of the preceding claims 7 to 11, characterized in that there are provided means of discriminating between tone and non-tone signals depending on whether the comparison value is greater or less than at least one reference value.

13. Computer program product with program coding means, characterized in that at least the steps according to at least one of the preceding method claims are executed if the program coding means are implemented on a computer or processor.

14. Data carrier with a computer program having program coding means, characterized in that at least the steps according to at least one of the preceding method claims are executed if the program coding means are implemented on a computer or processor.
